(19) United States
(12) Patent Application Publication
(10) Pub. No.: US 2005/0052451 A1
(43) Pub. Date: Mar. 10, 2005

(54) Method for the synthesis of a 3D intervisibility image

(76) Inventor: Xavier Servantie, Pessac (FR)

Correspondence Address: LOWE HAUPTMAN GILMAN & BERNER, LLP, Suite 300, 1700 Diagonal Road, Alexandria, VA, 22314, US

(21) Appl. No.: 10/715,847

(22) Filed: Nov. 19, 2003

(30) Foreign Application Priority Data
Nov. 22, 2002 (FR) 02 14682

(51) Int. Cl. G06T 15/00

(52) U.S. Cl. 345/419

(57) ABSTRACT

The field of the invention is that of methods for the synthesis of a 3D mapping image consisting of pixels and representing the distribution of the intervisibility area on a terrain overflown by an aircraft. An intervisibility area is understood to mean the area within range of a known potential threat. The method of the invention represents the intervisibility area in the form of the surface layer constituted by points belonging to the sphere covered by the threat, such that the distance from each point of the surface layer to the point of the terrain having the same geographical coordinates should be as small as possible. This arrangement enables the aircraft pilot to have very clear and very easily interpretable information available to him. Furthermore, the method requires limited computation resources. This facilitates its implementation in onboard mapping generators.

### BACKGROUND OF THE INVENTION

1. Field of the Invention

The field of the invention is that of methods for the synthesis of mapping images formed by pixels and representing the distribution of the intervisibility zones or areas on a terrain overflown by an aircraft.

An intervisibility area Z is an area within range of a known potential threat. If the threat M has a radius of range R, then this range is a portion of a sphere S bounded in its lower part by the relief of the terrain T in which the threat is located, as indicated in FIG. 1. FIG. 2 shows that, depending on terrain relief features, there are areas which, although they are located at a distance D smaller than the radius of range R, are not in the area of intervisibility of the threat M. As a consequence, the presence or absence of an aircraft in the area of intervisibility of a threat will depend not only on its geographical position but also on its altitude. For example, in FIG. 2, the aircraft A is outside the area of intervisibility at the altitude H and is in the area of intervisibility at the altitude H′.

Given the importance of this information for the security of an aircraft, the representation of intervisibility information on the display screens of the instruments panel of said aircraft must be as clear and as ergonomical as possible. The representation of the zones of intervisibility by methods of mapping image synthesis is therefore a major and difficult problem.

2. Description of the Prior Art

Historically, the first views of the zones of intervisibility were made by what is called the “ray-tracing” technique. The U.S. Pat. No. 5,086,396 is representative of this technique. Rays are traced from the position of the threat considered up to either an obstacle limiting the effective range of the threat or the boundary of the theoretical range when there are no obstacles. The result can be seen in FIG. 6 of said American patent. The area of intervisibility corresponds to the zone covered by the rays. The theoretical range of the threat is indicated by a generally circular line 23A. In a preferred option, in the claim 7, said American patent proposes to assign a different color to each family of rays representing a different type of threat, no doubt in order to enable the pilot to distinguish between the different types of threat. This grid of rays launched from the threat is overlaid on the coloring of the displayed map. This prior art patent has several drawbacks. Thus this prior art patent leads to the loss of certain pieces of information such as shading information representing the relief of the terrain for example, in the parts of the map covered by rays. For the parts of the map that are in the areas of intervisibility of several threats, possibly of a different type, it becomes difficult or even impossible for the aircraft pilot to read the information conveyed by the map covered by the interlacing of the rays. Besides, the area within range is indicated only by its boundary, which does not always enable the pilot to view it properly it in its totality.

The present applicant has proposed significant improvements to the “ray-tracing” (in patent application No. 01 08669). This method can be applied especially to mapping representations known as 2D5 representations. A 2D5 mapping representation is a classic 2D representation in which the information on relief has been shown in the form of shading. The principle proposed reduces all or part of the drawbacks of the prior art by using unified colors that uniformly cover the different parts of the intervisibility zone considered, as opposed to the grid type textured colors of the prior art, partially covering the zone considered, thus making it possible to avoid losing at least certain pieces of information conveyed by the map displayed, and especially the shading information representing the ground relief. Each type of area then has a different color associated with it. Thus, for example, a first area located outside the range of the threat has a first color, a second area located within range of the threat but outside the area of intervisibility has a second color and finally a third area located in the area of intervisibility has a third color. The size of the areas depends on the altitude of the aircraft. For example, the greater the altitude of said aircraft, the smaller becomes the size of the second area.

In the case of 3D depictions of the terrain, the area of intervisibility can also be represented in the form of a semi-transparent spherical surface representing the boundaries of the area of intervisibility.

However, these methods still have certain drawbacks. For example, when the aircraft is located in the second area, located within range of the threat but outside the area of intervisibility, the pilot does not know the margin of altitude remaining before the aircraft penetrates the area of intervisibility. Similarly, it is fairly difficult for him to define the path that he must take in order to remain in complete safety, outside or below the area of intervisibility.

### SUMMARY OF THE INVENTION

It is the object of the invention to overcome these different drawbacks and present the pilot with the areas of intervisibility in a more ergonomic way, enabling the pilot to have sure knowledge firstly of whether the aircraft is in an area of intervisibility and secondly of when the aircraft is outside an area of intervisibility, and to know the margin of altitude remaining before the aircraft penetrates the area of intervisibility. The flight safety of the aircraft is thus substantially improved.

More specifically, an object of the invention is a method for the synthesis of an image for aeronautical applications, said image comprising at least:
A 3D mapping representation of a terrain overflown by an aircraft, said terrain comprising at least one potential threat;
A 3D representation of an area of intervisibility (Z) defined as a portion of the sphere representing the range of said threat;
   wherein the 3D representation of said area of intervisibility is formed by a surface layer corresponding to the lower surface of the area of intervisibility, said lower surface being constituted by points belonging to the area of intervisibility, such that the distance from each point of said lower surface to the point of the terrain having the same geographical coordinates is as small as possible.

Advantageously, the surface area appears semi-transparently in such a way that the areas of the terrain located beneath the layer remain partly visible.

Advantageously, the surface layer has a first side and a reverse side, the first side having a first color, and the reverse side having a second color, the second color being different from the first color. It is also possible for the first side or reverse side of the surface layer to have a texture. This texture is, for example, a regular grid. Advantageously, the lines of the grid are transparent.

Advantageously, to specify the boundaries of the perimeter of range, said perimeter of maximum range of the threat is represented in the form of the convex surface of a vertical texture with a constant pitch positioned on the terrain. This texture is, for example, a closed vertical grid positioned on the terrain.

### BRIEF DESCRIPTION OF THE DRAWINGS

The invention will be understood more clearly and other advantages shall appear from the following description given on a non-restrictive basis with reference to the appended drawings, of which:

FIG. 1 is a 3D view of a terrain comprising an area of intervisibility generated by a threat.

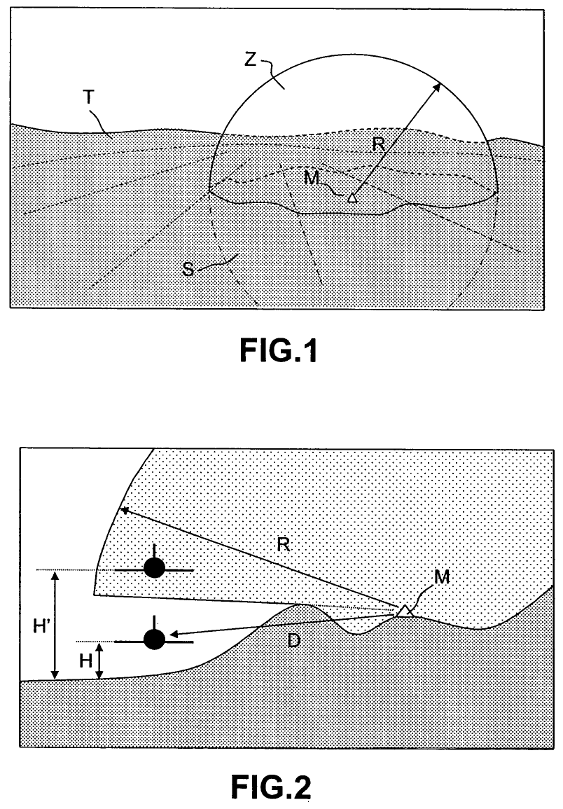

FIG. 2 is a sectional view of said terrain at the level of said area of intervisibility.

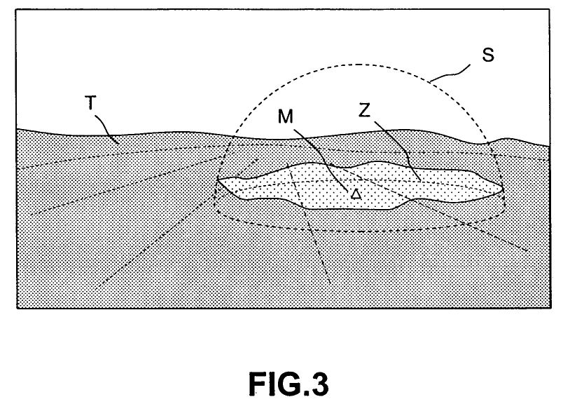

FIG. 3 is a 3D view of said terrain comprising said area of intervisibility generated by a threat, said area being represented according to the invention.

FIGS. 4a and 4b are a 3D view of a terrain with and without the representation of a part of an area of intervisibility generated by a threat, said area being represented according to a first mode of representation according to the invention.

FIGS. 5, 6 and 7 represent three 3D views of the terrain of FIG. 4b comprising a part of the area of intervisibility presented according to a second, third and fourth mode of representation according to the invention.

FIG. 8 is a 3D view of a terrain comprising the representation of a part of an area of intervisibility generated by a threat as well as the representation of the perimeter of maximum range of said threat.

### MORE DETAILED DESCRIPTION

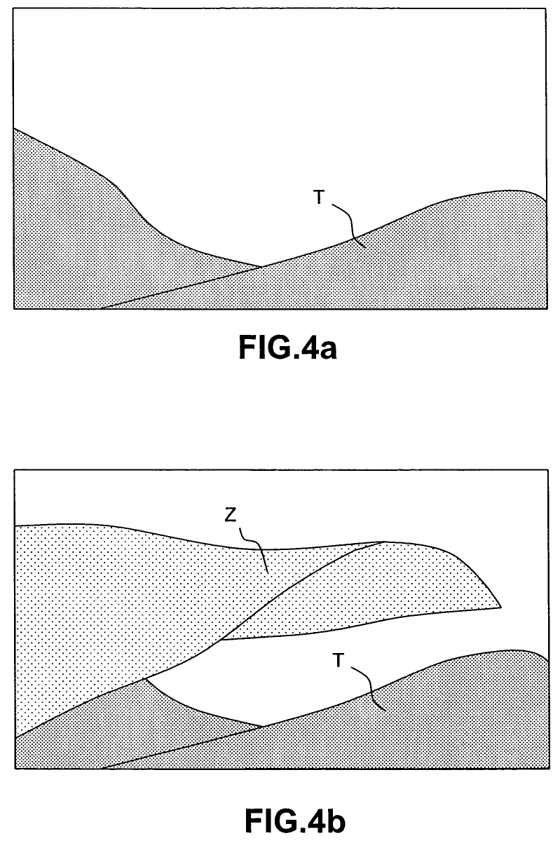

FIG. 3 shows a general 3D view of a terrain T comprising a threat M. The representation of the area of intervisibility Z according to the invention comprises only the surface layer constituted by the points belonging to the lower surface of the area of intervisibility, such that the distance from each point of the surface layer to the point of the terrain having the same geographic coordinates is as small as possible. When the aircraft is inside the sphere corresponding to the range but in an area located between the terrain and the surface layer, it is sheltered from the threat. As a consequence, the interpretation of the area of intervisibility is considerably simplified. Either the aircraft is located above the surface layer, in which case said aircraft is perceived by the threat and is in the area of intervisibility or the aircraft is located beneath the surface layer, in which case the aircraft is not perceived by the threat and is situated outside the area of intervisibility. The pilot is thus given a very simple criterion of security.

Furthermore, this simplification is of high technical value. Indeed, only one surface needs to be generated whereas, in many representations of areas of intervisibility, it is necessary to generate either several 3D surfaces or a complete volume. Thus, there is a saving in computation time. This point is important inasmuch as, of course, the images have to be generated in real time at a rate laid down by the video standards, i.e. at rate of about 25 images per second.

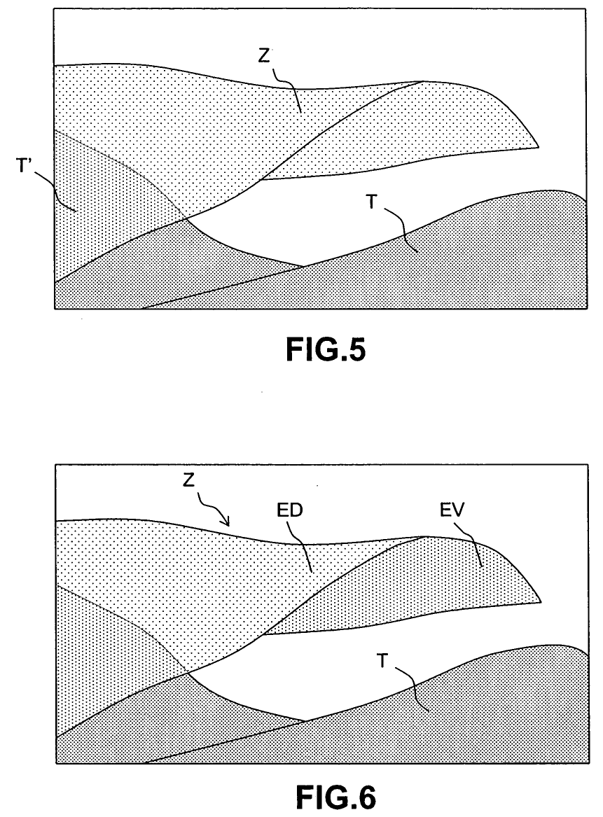

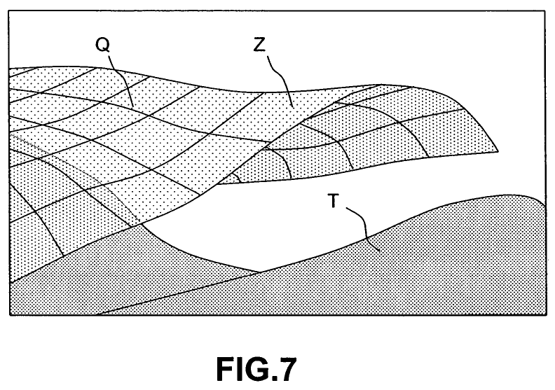

FIGS. 4a and 4b show a 3D view of a terrain T with and without the representation of a part of an area of intervisibility Z generated by a threat not shown in these figures, said area being represented by a uniform color according to a first mode of presentation. As can be seen in FIG. 4b, the interpretation of the area of intervisibility Z may be ambiguous. Complementary modes of presentation shown in FIGS. 5, 6 and 7 enable the presentation and the perception of the area of intervisibility to be refined.

Two points are essential for the readability of the area of intervisibility:
Perception of the relief of the surface layer.
Perception of the situation of the aircraft relative to this layer.

FIG. 5 shows a second mode of representation of the area of intervisibility. The surface layer is shown semi-transparently so that the relief of the terrain T′ located beneath the surface layer Z can be seen. This facilitates the sensation of the viewer concerning the position of the layer relative to the relief.

FIG. 6 shows a third mode of representation of the area of intervisibility. The surface layer has a first side and a reverse side. To improve the perception of the surface and prevent inversions of representation, two different colors are used for said first side and said reverse side. The utility of differentiating in this way between the first side and the reverse side of the surface layer appreciably improves the perception of the layer. For example, the first side facing the sky is shown in green. The reverse side, in this case, which faces the ground, is shown for example in pink. Consequently, if the pilot perceives the surface layer essentially as being pink, it means that it is beneath the surface layer and hence beneath the area of intervisibility. Reciprocally, if the pilot perceives the surface layer as being essentially green, this means that it is above the surface and, consequently, in the area of intervisibility.

FIG. 7 shows a fourth mode of representation of the area of intervisibility. A texture Q at constant pitch is positioned on the first side and/or the reverse side of the surface layer. The texture reveals the relief of the layer. When the pattern of the texture appears to be large-sized, it means that it is close to the aircraft. When the pattern of the texture appears to be small-sized, it means that it is at a distance from the aircraft. The variably sharp tilt of the pattern also improves the sense of the relief of the surface layer. The texture that is the simplest to be implemented and that least “loads” the image is the regular grid shown in FIG. 7. It must be noted that the overlaying of a texture does not entail specific computations. Indeed, the basis of the pattern is an image stored in a standard pattern and copied according to the pitch of the pattern throughout the surface of the image.

The mode of representation of FIG. 7 can be improved by representing the lines of the grid transparently. The terrain located beneath the area of intervisibility is made to appear in this way.

Naturally, it is possible to generate an image of intervisibility that mixes these different modes of representation.

When several threats are present with areas of intervisibility that are partially common, it is possible to represent the resulting area of intervisibility also in the form of a surface layer such that said layer is constituted by points belonging to the lower surfaces of the areas of intervisibility of the different threats, such that the distance from each point of the surface layer to the point of the terrain having the same geographical coordinates is as small as possible.

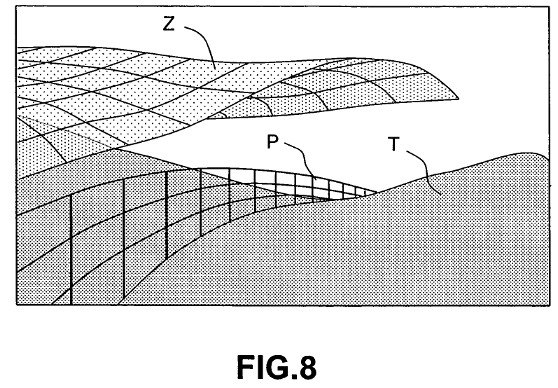

FIG. 8 shows a 3D view of a terrain T comprising the representation of a part of an area of intervisibility generated by a threat as well as the representation of the perimeter P of maximum range of said threat. The representation of the perimeter P of a range tells the pilot of the aircraft that he is penetrating an area potentially covered by a threat even if he is outside the area of intervisibility. The perimeter is represented by the convex surface of a vertical texture with constant pitch, this texture being, for example, a closed vertical grid positioned on the ground. The sense of penetrating a dangerous area is thus reinforced.

The method of synthesis according to the invention necessitates means that are usually available in the avionics systems of modern aircraft.

The full system enabling the display of the 3D image according to the invention comprises:
One or more man/machine interfaces of the control station type, enabling the pilot to select the information that he needs. For example, the pilot may seek a mapping representation of the terrain and of the area of intervisibility that is different from the one linked to the real position of the aircraft.
Means for the geographical localization of the aircraft in the space comprising:
   Position sensors (inertial guidance system, satellite positioning system of the type GPS (Global Positioning system) type, etc.);
   Attitude sensors (air data sensors, gyroscopic sensors, accelerometers, etc.)
   A navigation unit for the processing of the data coming from the chains of sensors and determining the geographical position, altitude and attitude of the aircraft.
A unit for the generation of a mapping synthesis 3D image of the terrain and at least the image of the area of intervisibility according to one of the modes of presentation according to the invention. Said unit comprises:
   A mapping database comprising at least the information on the relief of the terrain as well as the nature and the positioning of the different potential threats.
   A processing unit making it possible, as a function of the data coming from the processing unit as well as information given by the pilot, to generate the 3D image of the terrain and the area of intervisibility.
At least one MFD (multifunction display) type of display device on the instruments panel enabling the real-time representation of the 3D image of the terrain and of the area of intervisibility.
Electronic links connect the different units of the complete system. The different pieces of information are transmitted by data bus according to standards proper to aeronautics.

1. A method for the synthesis of an image for aeronautical applications, said image including 3D mapping representation of a terrain overflown by an aircraft, the terrain comprising at least one potential threat and 3D representation of an area of intervisibility defined as a portion of the sphere representing the range of said threat, the method comprising the steps of:
forming a 3D representation of said area of intervisibility by a surface layer corresponding to the lower surface of the area of intervisibility, said lower surface being constituted by points belonging to the area of intervisibility, such that the distance from each point of said lower surface to the point of the terrain having the same geographical coordinates is as small as possible.

2. The method for the synthesis of an image according to claim 1, further comprising revealing the surface layer in semi-transparency in such a way that the areas of the terrain located beneath the surface layer remain partly visible.

3. The method for the synthesis of an image according to claim 1, wherein the surface layer has a first face (ED) and a reverse face (EV), and further comprising making the first face appear in a first color and the reverse face appear in a second color, the second color being different from the first color.

4. The method for the synthesis of an image according to claim 1, further comprising making a texture appear on the first face or reverse face of the surface layer.

5. The method for the synthesis of an image according to claim 4, wherein the texture is a regular grid.

6. The method for the synthesis of an image according to claim 4, wherein the lines of the grid are transparent.

7. The method for the synthesis of an image according to claim 1, further comprising revealing the perimeter of the maximum range of the threat in the form of the convex surface of a vertical texture with constant pitch positioned on the terrain.

8. The method for the synthesis of an image according to claim 7, wherein said texture is a closed vertical grid positioned on the terrain.

9. A unit for the generation of a mapping synthesis image comprising a representation of the 3D image of a terrain overflown by an aircraft, said terrain comprising at least one threat, said mapping image also comprising a representation of the image of the area of intervisibility of said threat, wherein the method of synthesis of the mapping image is made according to claim 1.

10. An avionics system mounted on an aircraft comprising one or more interfaces of the control station type:
means for the geographical localization of the aircraft in space comprising sensors;
a navigation unit providing for the processing of data coming from chains of sensors;
a mapping data base comprising at least the information on relief of the terrain as well as the nature and the positioning of the different potential threats;
a unit for the generation of mapping images making it possible, as a function of the data coming from the navigation unit as well as information given by the pilot, to generate the 3D image of the terrain and of the area of intervisibility; and
an MFD (multifunction display) type display device positioned on the instruments panel enabling the real-time representation of the 3D image of the ground and of the area of intervisibility and of the electronic links connecting the different units of the system, wherein the mapping image generation unit is according to claim 9.

11. The method for the synthesis of an image, according to claim 2, wherein the surface layer has a first face (ED) and a reverse face (EV), and further comprising making the first face appear in a first color and the reverse face appear in a second color, the second color being different from the first color.

12. The method for the synthesis of an image, according to claim 2, further comprising making a texture appear on the first face or reverse face of the surface layer.

13. The method for the synthesis of an image, according to claim 3, further comprising making a texture appear on the first face or reverse face of the surface layer.

14. The method for the synthesis of an image, according to claim 5, wherein the lines of the grid are transparent.

15. The method for the synthesis of an image, according to claim 6, further comprising revealing the perimeter of the maximum range of the threat in the form of the convex surface of a vertical texture with constant pitch positioned on the terrain.

16. The unit for the generation of a mapping synthesis image, according to claim 9, wherein said method comprises means to reveal the surface layer in semi-transparency in such a way that the areas of the terrain located beneath the surface layer remain partly visible.

17. The unit for the generation of a mapping synthesis image, according to claim 9, wherein the surface layer having a first face (ED) and a reverse face (EV), said method comprises means to make the first face appear in a first color and the reverse face appear in a second color, the second color being different from the first color.

18. The unit for the generation of a mapping synthesis image, according to claim 9, wherein said method comprises means to reveal the perimeter of the maximum range of the threat in the form of the convex surface of a vertical texture with constant pitch positioned on the terrain.

19. The avionics system mounted on an aircraft according to claim 10, wherein said method comprises means to reveal the surface layer in semi-transparency in such a way that the areas of the terrain located beneath the surface layer remain partly visible.

20. The avionics system mounted on an aircraft according to claim 10, wherein the surface layer having a first face (ED) and a reverse face (EV), said method comprises means to make the first face appear in a first color and the reverse face appear in a second color, the second color being different from the first color.

21. The avionics system mounted on an aircraft according to claim 10, wherein said method comprises means to reveal the perimeter of the maximum range of the threat in the form of t he convex surface of a vertical texture with constant pitch positioned on the terrain.
